(19) United States
(12) Patent Application Publication
(10) Pub. No.: US 2004/0164729 A1
(43) Pub. Date: Aug. 26, 2004

(54) Rotational angle detection devices

(75) Inventors: Tutomu Ikeda, Aichi-ken (JP); Kazumasa Nakashima, Aichi-ken (JP)

Correspondence Address: Ira J. Schultz, DENNISON, SCHULTZ, DOUGHERTY & MACDONALD, Suite 105, 1727 King Street, Alexandria, VA, 22314-2700, US

(73) Assignee: Aisan Kogyo Kabushiki Kaisha

(21) Appl. No.: 10/781,813

(22) Filed: Feb. 20, 2004

(30) Foreign Application Priority Data
Feb. 21, 2003 (JP) 2003-044310

(51) Int. Cl. G01B 7/30

(52) U.S. Cl. 324/207.21; 324/207.25

(57) ABSTRACT

A rotational angle detecting device includes a magnet support and a pair of magnets attached to the magnet support. The magnets oppose each other to produce a substantially unidirectional magnetic field between the magnets. A sensor is disposed within the magnetic field and serves to detect the change of direction of the magnetic field as the magnets and sensor rotate relative to each other. The sensor outputs a signal or signals representing the relative rotational angle across the entire range of relative rotation between the sensor and the magnets.

This application claims priorities to Japanese patent application serial number 2003-44310, the contents of which are incorporated herein by reference.

### BACKGROUND OF THE INVENTION

1. Field of the Invention

The present invention relates to devices for detecting rotational angles of rotary members, such as rotary shafts.

2. Description of the Related Art

FIG. 5 shows a known device 101 for detecting rotational angles. The known device 101 includes a yoke 110 and a permanent magnet 120. The yoke 110 is coupled to a rotary shaft (not shown) so that the yoke 110 rotates as the rotary shaft rotates. The permanent magnet 120 is mounted to the inner circumferential surface of the yoke 110 and has a hollow configuration with a bore having a circular cross section. A sensor 170 for detecting the strength of a magnetic field is disposed at substantially the center of the yoke 110 and may be a hall element or like element. The sensor 170 may output a signal that corresponds to the strength of the magnetic field produced within the yoke 110 by the permanent magnet 120 at a position where the magnetic field lines intersect the sensor 170. Thus, as the yoke 110 rotates with the rotary shaft, the strength of the magnetic field at the position where the magnetic field lines intersect the sensor 170 may vary, so that the output signal from the sensor 170 may vary. Therefore, the known device 101 is configured to detect the rotational angle of the rotary shaft based upon the change of the output signal from the sensor 170. Japanese Laid-Open Patent Publication No. 61-75213 discloses this type of device.

However, in case of the known device 101, the strength of magnetic field at the position where the magnetic field lines intersect the sensor 170 varies linearly in proportion to the change in the rotational angle of the yoke 110, but only within a limited range. Therefore, it is not possible to accurately detect the rotational angle over the entire range of rotation.

To this end, Japanese Laid-Open Patent Publication No. 8-35809 has proposed a device 101a for detecting a rotational angle, as shown in FIG. 6, in which a pair of stators 160 and 161, each having a semi-circular cross section are disposed within the yoke 110. A gap 162 is formed between the stators 160 and 161, and the sensor 170 is positioned within the gap 162 for detecting the strength of a magnetic field. With this arrangement, the direction of the magnetic field where the magnetic field lines intersect the sensor 170 is directed in primarily one direction, i.e., a direction indicated by the arrows across the gap 162 as viewed in FIG. 6, irrespective of change of the rotational angle of the yoke 110. Therefore, the sensor 170 can properly detect the rotational angle of the rotary shaft over the entire range of rotation.

However, the incorporation of the stators 160 and 161 may increase the total number of parts of the device for detecting rotational angles and therefore may increase the manufacturing cost. In addition, an increase of the number of parts may consequently increase the demand for accuracy in the assembling operation.

### SUMMARY OF THE INVENTION

It is accordingly an object of the present invention to teach improved rotational angle detection devices that can accurately detect a rotational angle in addition to being relatively easily manufactured at low costs.

According to one aspect of the present teachings, rotational angle detecting devices are taught that include a magnet support (e.g. a yoke) and at least a pair of magnets (e.g., ferritic magnets). The magnets are attached to the magnet support so that the magnets are positioned to generate a substantially unidirectional uniform magnetic field across the axis of rotation. In some embodiments, the magnets may be positioned opposed to each other across the axis of rotation. A sensor is disposed within the magnetic field and serves to detect the change of direction of the magnetic field as the magnets and the sensor rotate relative to each other. The sensor then outputs signals representing a relative rotational angle corresponding to the detected change of direction of the magnetic field. The sensor, for example, may be an integrated circuit that includes a magnetic resistance element.

Because the sensor does not detect the strength of the magnetic field but instead detects the direction of the magnet field, the sensor is not significantly influenced by possible changes of the magnetic forces of the magnets due to heat, possible offset of position of the sensor from a set position due to thermal expansion of the sensor or due to wear of a rotary shaft for which the rotational angle is detected, or possible offset of the magnets from their desired positions during the assembling operation of the magnets. Therefore, the rotational angle can be accurately detected and the assembling operation of the device can be easily performed.

In another aspect of the present teachings, the magnets are disposed substantially symmetrically with respect to a center positioned within the magnetic field. The sensor is positioned substantially at the center so that the detection of a change of the direction of the magnetic field can be reliably preformed.

In another aspect of the present teachings, the magnet support is a substantially tubular member and the magnets are attached to an inner peripheral surface of the tubular member.

In another aspect of the present teachings, the magnets are magnetized to produce substantially parallel magnetic field lines that intersect the sensor. Therefore, the sensor can more accurately detect the change of direction of the magnetic field lines as the magnets rotate relative to the sensor.

In another aspect of the present teachings, each of the magnets has an arc-shaped configuration along a circumferential direction of the tubular member and has a thickness in a radial direction of the tubular member. The thickness of each magnet is substantially uniform along the circumferential direction of the tubular member.

In another aspect of the present teachings, each of the magnets has opposite end surfaces along a circumferential direction. Each of the end surfaces extends along the radial direction of the tubular member, orthogonal to the inner surface of the circumference. Alternatively, each of the end surfaces may comprise a first surface and a second surface that intersect with each other and are respectively inclined by obtuse angles relative to an inner circumferential surface and an outer circumferential surface of each of the magnets. With this arrangement, possible damage during the machining operation of the material for forming the magnets can be minimized.

In another aspect of the present teachings, each of the magnets extends over an angle about the center, i.e., the center of symmetrical arrangement of the magnets. This angle is set such that the error of the output signal from the sensor, due to an offset of the sensor position from the desired center position, is less than a predetermined value.

With this arrangement, the error of the output signal can be within a desired tolerance value even if the position of the sensor has been offset from the center. Therefore, the assembling operation of the device can be made without the costs of requiring an extremely accurate positioning of the sensor at the center.

In another aspect of the present teachings, the angle describing the length of each magnet is determined based on factors including a possible maximum offset distance of the sensor from the center, the material of the magnets, and the thickness of each of the magnets in a radial direction about the center. Preferably, the possible maximum offset distance is chosen to be approximately 0.75 mm.

In another aspect of the present teachings, the magnets are made of ferrite-based magnetic materials. Because the ferrite-based magnet materials can be easily machined to have a desired configuration, this material facilitates the machining operation.

### BRIEF DESCRIPTION OF THE DRAWINGS

FIG. 1(A) is a cross sectional view of a first representative device for detecting a rotational angle; and

FIG. 1(B) is a vertical sectional view of the first representative device; and

FIGS. 2(A), 2(B), and 2(C), are cross sectional views similar to FIG. 1(A), but illustrating various configurations of magnetic field lines that may be produced when the angular range of magnets of the first representative device is varied; and

FIG. 3 is a graph illustrating the relation between the angular range of the magnets and an error of the detected angle when the position of a sensor of the first representative device has been offset from the center; and

FIG. 4 is a cross sectional view similar to FIG. 1(A) but showing a second representative device for detecting a rotational angle; and

FIG. 5 is a cross sectional view of a known device for detecting a rotational angle; and

FIG. 6 is a cross sectional view of another known device for detecting a rotational angle.

### DETAILED DESCRIPTION OF THE INVENTION

Each of the additional features and teachings disclosed above and below may be utilized separately or in conjunction with other features and teachings to provide improved rotational angle detecting devices and methods of using such improved rotational angle detecting devices. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

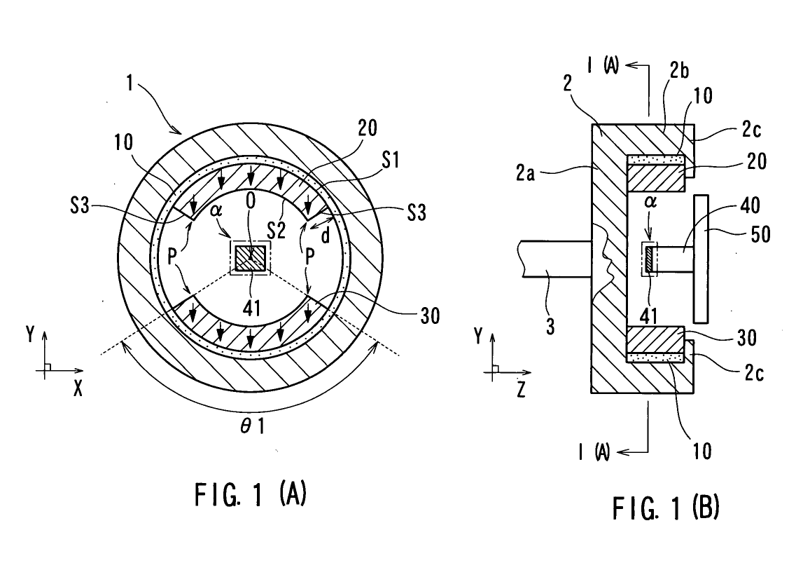

A first representative embodiment will now be described with reference to FIGS. 1(A), 1(B), 1(C), 1(D), and 1(E). Referring to FIG. 1(B), a first representative rotational angle detecting device 1 is shown in a cross sectional view. The rotational angle detecting device 1 includes a housing 2 attached to one end of a rotary shaft 3 and is adapted to detect the rotational angle of the rotary shaft 3. For example, the rotary shaft 3 may be a throttle shaft that is coupled to a throttle valve (not shown) for controlling the flow of intake air supplied to an internal combustion engine of an automobile. As shown in FIG. 1(A), the housing 2 includes a circular disk portion 2a, a cylindrical tubular portion 2b, and an annular engaging portion 2c that are formed integrally with each other. The disk portion 2a is secured to one end of the rotary shaft 3, so that the housing 2 rotates as the rotary shaft 3 rotates. The tubular portion 2b extends from one side of the disk portion 2a opposite to the rotary shaft 3. The engaging portion 2c extends inward towards the axis at one end of the tubular portion 2b opposite to the disk portion 2a. As a result, the whole device 1 has a substantially C-shaped configuration when viewed in a vertical cross section as shown in FIG. 1(B). A substantially cylindrical tubular yoke 10 is attached to the inner peripheral surface of the tubular portion 2b and is fixed in position between the disk portion 2a and the engaging portion 2c. A pair of arc-shaped magnets 20 and 30 are attached to the inner peripheral surface of the yoke 10 and are positioned symmetrically with respect to a center O. In this representative embodiment the center O coincides with the center of the yoke 10 as viewed in the cross sectional view shown in FIG. 1(A) and also coincides with the central axis of the rotary shaft 3. Although the details of the magnets 20 and 30 will be explained later, each of the magnets 20 and 30 is magnetized in one direction (the vertical direction as shown by the arrows in FIG. 1(A)) throughout the circumferential length (parallel magnetization). In addition, the magnets 20 and 30 are arranged to produce a magnetic field that has parallel magnetic field lines in the vertical direction as viewed in FIG. 1(A). The magnetic field lines extend within the inner space of the yoke 10 across a sensor 41 that is disposed at the center O. The sensor 41 serves to detect the direction of the magnetic field lines.

Referring to FIG. 1(B), a base plate 50 is secured to a fixed mounting at a predetermined position. A rod-like support member 40 is attached to the base plate 50 and has a longitudinal axis that coincides with the rotational axis of the rotary shaft 3. The support member 40 has a front portion that extends into the inner space of the yoke 10, so that the front portion of the support member 40 is positioned to extend through the center O of the yoke 10. The sensor 41 is attached to the end of the front portion.

The sensor 41 is operable to output signals in response to the direction of the magnetic field lines of the magnetic field that intersects the sensor 41. More specifically, the output signals may vary linearly with a change in the direction of the magnetic field lines. In other words, the output signals may vary in proportion to the change of the direction of the magnetic field lines. For example, the sensor device 41 may be an IC that utilizes a magnetic resistance element.

The configurations of the magnets 20 and 30 will now be described in more detail. Because the magnets 20 and 30 are made of the same material and have the same configuration, only one representative magnet will be described. The magnet 20 is made of a ferrite-based magnetic material and is secured to the inner peripheral surface of the yoke 10. The ferrite-based magnetic material is known to be softer, but also tougher, than a rare-earth magnetic material, so that the ferrite-based magnetic material can be easily formed or machined to have a curved configuration. In addition, the material cost of the ferrite-based magnetic material is lower than the cost of the rare-earth magnetic material. An outer peripheral surface S1 of the magnet 20 has a radius about the center O. The radius of surface S1 is substantially the same as the radius of the inner peripheral surface of the yoke 10. An inner peripheral surface S2 of the magnet 20 also has a radius about the center O. The length of the radius of the inner peripheral surface S2 is smaller than the radius of the outer peripheral surface S1 by a distance corresponding to a thickness d of the magnet 20. The magnet 20 has opposite end surfaces S3 along the circumferential direction. Each of the end surfaces S3 is orthogonal to the inner peripheral surface of the yoke 10 and extends along a radial direction towards the center O. Preferably, the thickness d of the representative magnet 20 is approximately 3 mm, although the thickness d may be determined by taking into account the machining or forming operations of the magnet.

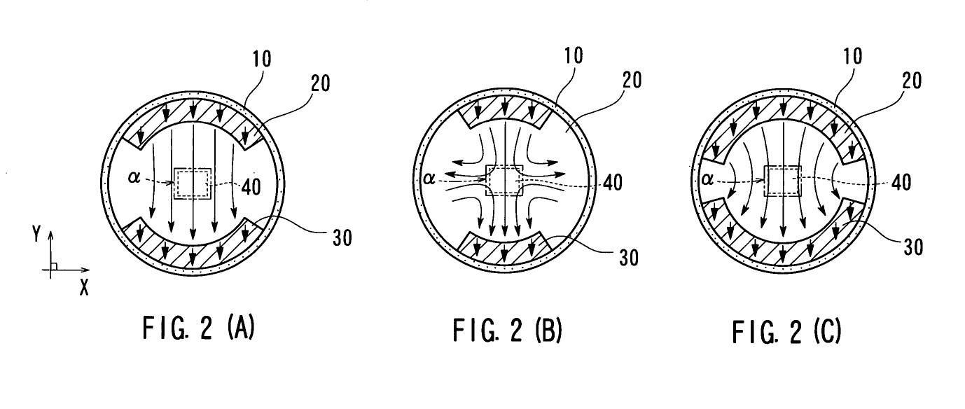

A central angle θ1 of a sector defined by the center O and corners P, the corners formed by the inner peripheral surface S2 (i.e. the inner diameter) and the end surfaces S3, of the representative magnet 20 will now be described with reference to FIGS. 2(A), 2(B), and 2(C).

By appropriately determining the value of the angle θ1, the magnets 20 and 30 can produce a magnetic field that will have substantially parallel magnetic field lines within a region including the sensor 41 and corresponding substantially to the entire circumferential length of the magnets 20 and 30 as shown in FIG. 2(A).

However, if the angle θ1 is too small, the magnets 20 and 30 may produce a magnetic field that has magnetic field lines that are not parallel to each other, as shown in FIG. 2(B). Similarly, if the angle θ1 is too large, the magnets 20 and 30 may also produce a magnetic field that has magnetic field lines that are not parallel to each other, as shown in FIG. 2(C).

If the angle θ1 is appropriately determined to produce substantially parallel magnetic field lines across the sensor 41, an additional advantage is that the output signals from the sensor 41 will not be affected by a small offset or deviation of the position of the device 41 away from the center O. For example, due to an error in the assembling operation, there is a possibility that the sensor 41 is not accurately positioned at the exact center O but is offset from the center O by a small distance. Thus, if the angle θ1 is appropriately determined as shown in FIGS. 1(A) and 2(A), a tolerance offset area a for the placement of sensor 41 can be ensured.

If the angle θ1 is not appropriately determined, as in the cases shown in FIGS. 2(B) and 2(C), the direction of the magnetic field lines may vary in part due to the amount that the location of the mounting position of the sensor 41 has been offset from the center O, even if the location is still within a tolerable range a as determined in FIG. 2(A), where the angle θ1 is appropriately calculated. As a result, it is possible that the output signals of the sensor 41 of FIGS. 2(B) and 2(C), the signals produced in response to the detection of the direction of the magnetic field, may have errors. Therefore, if angle θ1 is not appropriately determined, the tolerable range for the positioning of the sensor 41 is very limited, and the resulting assembling operation of the sensor 41 must be made with a high degree of accuracy.

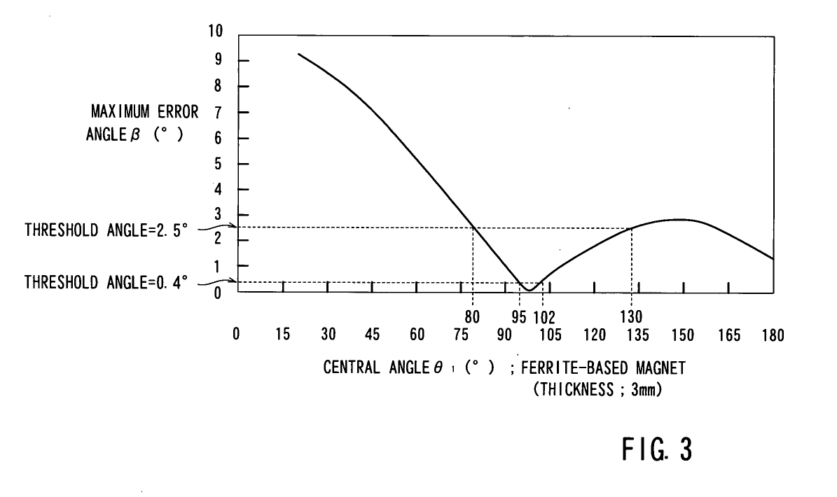

FIG. 3 shows a graph in which the abscissa indicates the angle θ1 (°) and the ordinate indicates the maximum projected error of an output signal from the sensor 41, i.e., the potential maximum error angle β (°) of the detected angle resulting from the placement of the sensor at an offset distance α1 (mm) from the center O when a ferrite-based magnetic material is used for the magnets 20 and 30. Here, an offset distance α1 is set to be approximately ±0.75 mm with respect to the x, y, and z, directions. The x, y, and z, directions are indicated in FIGS. 1(A) and 1(B). The x and y directions are perpendicular to each other and are perpendicular to the longitudinal axis of the rotary shaft 3. The z direction coincides with the longitudinal axis of the rotary shaft 3.

As will be seen from FIG. 3, if a desired threshold value for the maximum error angle β (°) is set to be 2.5°, the resultant angle θ1 is chosen to be between 80° and 130°. On the other hand, if a threshold value for the maximum error angle β (°) is set to be 0.4°, the angle θ1 is chosen to be between 95° and 102°.

In this way, a desired tolerable error, or the maximum error angle β (°), can be obtained by suitably determining the value of the angle θ1. For example, as noted above, if the angle θ1 is chosen to be between 95° and 102°, the resulted maximum error angle β (°) is relatively small, approximately 0.4°.

The operation of the above first representative embodiment will now be described. As previously detailed above, by appropriately determining the angle θ1 of the sector defined by the center O and the corners P, the magnetic field lines of the magnetic field produced by the magnets 20 and 30 are directed substantially parallel to each other. In addition, the magnetic field lines extend across the sensor 41 (capable of detecting the direction of the magnetic field) that is positioned substantially at the center of the inner space of the yoke 10, as shown in FIG. 2(A).

As the magnets 20 and 30, as well as the yoke 10 attached to the housing 2, rotate as the rotary shaft 3 rotates, the direction of the magnetic field lines intersecting the sensor 41 change in response to the rotational angle of the rotary shaft 3. Correspondingly, the output signal from the sensor 41 changes along with the rotational angle of the rotary shaft 3. A control unit, e.g., a CPU (not shown), receives the output signal from the sensor 41 and calculates the rotational angle of the rotary shaft 3 based upon the output signal. However, the sensor 41 may have a self-contained control unit in order to calculate the rotational angle of the rotary shaft 3.

The first representative rotational angle detection device 1 has a relatively simple construction. One of the few requirements is for the sensor 41 to be supported at approximately the center C within the yoke 10 in order to enable the sensor 41 to detect the relative angle of rotation between the shaft 3 and the sensor 41. Therefore, the rotational angle detection device 1 is relatively easy to assemble.

In addition, in the first representative device 1, the sensor 41 detects the direction of the magnetic field as opposed to the strength of the magnetic field as in the known devices. Because of the sensor 41, the rotational angle can be accurately detected over the entire range of the rotational angle. As a result, the first representative rotational angle detection device 1 does not require the stators 160 and 161 that are necessary in case of the known detection device shown in FIG. 6. For this and other reasons, the first representative rotational angle detection device 1 requires fewer parts as compared to the known devices, allowing the manufacturing costs to be reduced.

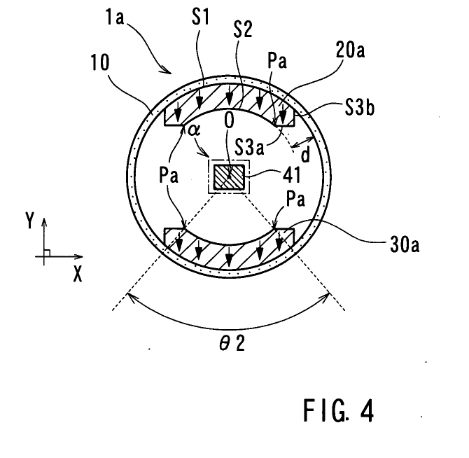

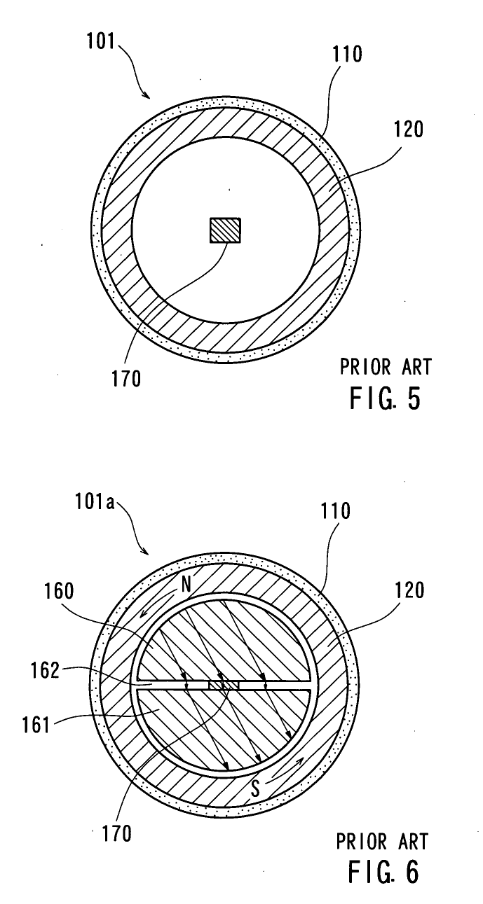

A second representative embodiment will now be described with reference to FIG. 4. A second representative rotational angle detection device 1a is primarily different from the first representative rotational angle detection device 1 in the incorporation of magnets 20a and 30a. Magnets 20a and 30a have a slightly different configuration from the magnets 20 and 30 of the first representative device 1a. Therefore, in the description of FIG. 4, like members are given the same reference numerals as in the first representative embodiment and an initial explanation may not be repeated. The material and the magnetizing direction of the magnets 20a and 30a are the same as in the magnets 20 and 30.

As described previously, each of the end surfaces S3 along the circumferential direction of the magnets 20 and 30 extends along a radius that passes through the center O. In contrast, each of the end surfaces along a circumferential direction of the magnets 20a and 30a of the second representative rotational angle detection device 1a includes a first surface S3a and a second surface S3b. The first surface S3a extends generally perpendicular to the magnetizing direction of the magnets 20a and 30a. The second surface S3b extends substantially parallel to the magnetizing direction of the magnets 20a and 30a. Each of the end surfaces has a triangular configuration. In particular, the first surface S3a and the second surface S3b intersect with the inner peripheral surface S2 and the outer peripheral surface S1, respectively by obtuse angles. The first surface S3a and the second surface S3b intersect at approximately right angles to each other.

A central angle θ2 of a sector defined by the center O and corners Pa, formed by the intersection of inner peripheral surface S2 (i.e., the inner diameter) and the first surfaces S3a of the magnet 20a (30a). Central angle θ2 corresponds to the central angle θ1 of the first representative embodiment.

In this second representative embodiment as in the first representative embodiment, by appropriately determining the angle θ2, magnets 20a and 30a produce a magnetic field that has substantially parallel magnetic field lines extending across the device 41 located within the inner space of the yoke 10. Therefore, in the same manner as in the first representative embodiment, if a threshold value for the maximum error angle β (°) is set to be approximately 2.5° and the offset distance α1 is set to be about ±0.75 mm with respect to x, y, and z, directions, the corresponding angle θ2 is chosen to be between 80° and 130°. On the other hand, if a threshold value for the maximum error angle β (°) is set to be approximately 0.4°, the angle θ2 is chosen to be between 95° and 102°. Thus, the operation and the advantages of the second representative embodiment are substantially the same as in the first representative embodiment.

In addition, according to the second representative device 1a, the first surface S3a and the second surface S3b of each of the end surfaces of the magnets 20a and 30a, respectively intersect with the inner peripheral surface S2 and the outer peripheral surface S1 by obtuse angles. Therefore, lessening the potential of damage during the machining or forming operations of the magnets 20a and 30a. This increase in resistance to damage is due in part to the reduction from two substantially perpendicular intersections per end surface in the first embodiment to only one substantially perpendicular intersection and two obtuse intersections per end surface in the second embodiment. As a result, the magnets 20a and 30a can be more easily machined or formed. In addition, the assembly operation of the rotational angle detection device 1a can be facilitated without the same level of concern over the accidental breaking of the right corners of the magnets of the rotational angle detection device 1.

The present invention may not be limited to the first and second representative embodiments detailed above, but may be modified in various ways.

For example, although the magnets 20 and 30 (and corresponding 20a and 30a) of the above representative embodiments are made of a ferrite-based magnetic material, they may be made of any other magnetic materials. Because the detection properties of the sensor 41 may vary in response to the selection of the material of the magnets, the relationship between the maximum error angle β (°) and the offset distance α1 (mm) may be obtained through experiments or calculations for various central angles θ1 (θ2) and/or for various thicknesses of the magnets. Based on the obtained relationship, an appropriate value of the central angle θ1 (θ2) and/or an appropriate thickness of the magnets can be selected.

In addition, in the first and second representative embodiments although the yoke 10 rotates with the rotary shaft 3 and the sensor 41 is fixed in position, the sensor 41 may rotate with the rotary shaft 3 and the yoke 10 may be fixed in position. In such an arrangement, the sensor 41 may be secured to the rotary shaft 3 and may serve to detect the rotational angle of the sensor 41 (i.e., the rotary shaft 3) relative to the yoke 10.

Further, the sensor 41 may have any construction as long as the sensor 41 can detect the change of the direction of a magnetic field and can output a signal or signals corresponding to the change of direction of a magnetic field.

1. A rotational angle detecting device comprising:
a magnet support;
at least two magnets attached to the magnet support, so that the magnets produce a magnetic field across a center of rotation;
a sensor disposed within the magnetic field and arranged and constructed to detect a change of direction of the magnetic field as the magnets and sensor rotate relative to each other;
wherein the sensor outputs signals representing a relative rotational angle.

2. A rotational angle detecting device as in claim 1, wherein the at least two magnets are disposed substantially symmetrically with respect to the center of rotation.

3. A rotational angle detecting device as in claim 2, wherein the sensor is positioned substantially at the center of rotation.

4. A rotational angle detecting device as in claim 3, wherein the magnet support comprises a substantially tubular member, and
the at least two magnets are attached to an inner peripheral surface of the tubular member, and
the substantially tubular member has a central axis along the center of rotation.

5. A rotational angle detecting device as in claim 4, wherein the magnets are magnetized to produce a substantially uniform magnetic field that intersects the sensor, and wherein the substantially uniform magnetic field can be represented by substantially parallel, unidirectional, magnetic field lines intersecting the sensor.

6. A rotational angle detecting device as in claim 4, wherein each of the magnets has an arc-shaped configuration along a circumferential direction of the tubular member.

7. A rotational angle detecting device as in claim 6, wherein each of the magnets has a thickness in a radial direction of the tubular member, and the thickness of each magnet is substantially uniform along the circumferential direction of the tubular member.

8. A rotational angle detecting device as in claim 6, wherein each of the magnets has opposite end surfaces along the circumferential direction.

9. A rotational angle detecting device as in claim 8, wherein each of the end surfaces extends along the radial direction of the tubular member from the inner peripheral surface of the tubular member towards the center of rotation.

10. A rotational angle detecting device as in claim 8, wherein each of the end surfaces comprises a first surface and a second surface that are respectively substantially aligned with a direction of the magnetic field and substantially aligned perpendicular to the direction of the magnetic field.

11. A rotational angle detecting device as in claim 3, wherein each of the magnets extends along an angle measured about the center of rotation, and
wherein the angle is determined such that an error of the output signal from the sensor due to an offset of a location of the sensor away from the center of rotation is less than a predetermined value.

12. A rotational angle detection device as in claim 11, wherein the angle is determined based on factors comprising a maximum offset distance tolerance of the sensor from the center of rotation, the material of the magnets, and a thickness of each of the magnets in a radial direction about the center of rotation.

13. A rotational angle detection device as in claim 12, wherein the possible maximum offset distance tolerance is about 0.75 mm.

14. A rotational angle detection device as in claim 2, wherein the magnets are made of ferrite-based magnetic materials.

15. A rotational angle detection device as in claim 2, wherein the sensor comprises an integrated circuit that includes a magnetic resistance element.

16. A rotational angle detecting device comprising:
a magnet support;
a pair of magnets attached to the magnet support, so that the magnets produce a magnetic field across a center of rotation;
wherein the magnetic field is substantially uniform and unidirectional across the center of rotation;
a sensor disposed within the magnetic field and arranged and constructed to detect a change of direction of the magnetic field as the magnets and sensor rotate relative to each other;
wherein the sensor outputs signals representing a relative rotational angle.

17. A rotational angle detecting device as in claim 16, wherein the pair of magnets are disposed substantially symmetrically with respect to the center of rotation; and
wherein the sensor is positioned substantially at the center of rotation.

18. A rotational angle detecting device as in claim 17, wherein each of the magnets has opposite end surfaces along the circumferential direction, and
wherein each of the end surfaces comprises a first surface and a second surface that intersect with each other and are respectively inclined relative to an inner circumferential surface and an outer circumferential surface of each of the magnets by obtuse angles.

19. A rotational angle detecting device as in claim 17, wherein each of the magnets has opposite end surfaces along the circumferential direction, and
wherein each of the end surfaces is substantially orthogonal to an outer circumferential surface of each of the magnets.
